(19) United States
(12) Patent Application Publication
(10) Pub. No.: US 2010/0238929 A1
(43) Pub. Date: Sep. 23, 2010

(54) METHOD FOR CLASSIFYING NETWORK PACKET

(75) Inventor: Jui-Pin Hsu, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ITE TECH. INC., Hsinchu (TW)

(21) Appl. No.: 12/464,115

(22) Filed: May 12, 2009

(30) Foreign Application Priority Data
Mar. 20, 2009 (TW) 98109180

(51) Int. Cl. H04L 12/56

(52) U.S. Cl. 370/392

(57) ABSTRACT

A method for classifying a network packet includes the steps of: receiving a network packet which includes a plurality of specific data; providing a basic rule table which includes a plurality of basic rules corresponding to the plurality of specific data; providing a composite rule table which includes a plurality of composite rules corresponding the packet classes, and each of the composite rules includes a specific calculation; each of the basic rules generates an output result according to the corresponding specific data; each of specific calculation generates a calculated result of the corresponding composite rule according to part or all of the output results; determining the packet class of the network packet according to the calculated results.

### CROSS-REFERENCE TO RELATED APPLICATION

This application claims the priority benefit of Taiwan application serial no. 98109180, filed on Mar. 20, 2009. The entirety of the above-mentioned patent application is hereby incorporated by reference herein and made a part of this specification.

### BACKGROUND OF THE INVENTION

1. Field of Invention

The present invention generally relates to a computer network, and more particularly to a method for classifying the network packet.

2. Description of Prior Art

To share the resource each other, the network has become a convenient, popular and important tool. The modern network switch/hub classifies the network packets, so as to meet the requirement of more flexible service. The modern network switch/hub gives the different quality of service (QoS) to the network packets, or gives the security of different levels to the network packets according to the virtual private network configurations of the network packets. In addition, the firewall used to protect the security of network determines whether the packet is allowed to transmit in the network based upon the technology of packet classification. The core technology of the new service on which the coming services depend is the technology of packet classification.

To achieve packet classification via the modern technology, mostly the header of the packet is analyzed. To take the case of Transmission Control Protocol/Internet Protocol (TCP/IP), a header of 104 bits of a packet is analyzed and searched in the rule data base, so as to determine application flow of the packet and how to process the packet. Wherein the header of 104 bits comprises an IP source address of 32 bits, an IP destination address of 32 bits, a protocol type of 8 bits, a source port number of 16 bits, and a destination port number of 16 bits.

Technology of packet classification is becoming more and more important, and recently many researchers propose related searching algorithms for technology of packet classification in international journals. For example, V. Srinivasan et al. propose a searching algorithm using the cross product published in “Fast and Scalable Layer 4 Switching.” ACM SIGCOMM'98, Vancouver, British; TV. Lakshman et al. propose a searching algorithm using 5 memory banks to search 1024 rules in “High-Speed Policy-Based Packet Forwarding Using Efficient Multi-dimension Range Matching.” ACM SIGCOMM'98, Vancouver, British; and N. Mckeown proposes a compression algorithm using the properties of rules in “Packet Classification On Multiple Fields.” Inforcomm 2000.

However, the conventional methods mentioned above usually have problems of low performance and large memory size under the worst condition, and do not meet the searching requirements of the other kinds, such as the IP routing table.

### SUMMARY OF THE INVENTION

One exemplary embodiment of the present invention provides a method for classifying a network packet. The method for classifying the network packet determines the assigned computer resources, such as the network bandwidth, the routing path of information, the choice of the server, the calculating schedule, and so on, according to the content of the network packet, so as to maintain the resource optimization of each application.

One exemplary embodiment of the present invention provides a method for classifying a network packet. The method for classifying the network packet is used to provide the QoS function of the real-time network and the bandwidth guarantee.

One exemplary embodiment of the present invention provides a method for classifying a network packet, and the method for classifying the network packet is used to classify the network packet. First, the network packet is received, and the network packet comprises a plurality of specific data. Then, a basic rule table is provided, wherein the basic rule table comprises a plurality of basic rules, and each basic rule corresponds to one of the plurality of specific data. Next, a composite rule table is provided, wherein the composite rule table comprises a plurality of composite rules, and each composite rule has one of a plurality of specific calculations, and corresponds to one of a plurality of packet classes. Then, each basic rule generates one of a plurality output results according to the corresponding specific data. Next, each specific calculation generates one of a plurality of calculated results according to part or all of the output results. Finally, the packet class of the network packet is determined according to the calculated results.

One exemplary embodiment of the present invention provides a method for classifying a network packet. First, network packet consisted with a communication protocol is received, wherein the communication protocol specifies N specific data, and N is a nature number. Next, a basic rule table comprising M basic rules is provided, wherein each of the M basic rules corresponds to one of the N specific data, and M is a nature number, and 0<M≦N; Then, the M specific data of the network packet are compared with the basic rules. When the one of the plurality specific data corresponding to the i^{th} basic rule matches with the i^{th} basic rule, an i^{th} compared result of a first logic is output. When the one of the plurality of specific data corresponding to the j^{th} basic rule do not match with the j^{th} basic rule, a j^{th} compared result of a second logic is output, wherein i and j are nature numbers, and 0<i≦M, 0<j≦M. Next, a plurality of composite rules are provided, wherein each composite rule corresponds to one of a plurality of packet classes, and the composite rules have a plurality of specific calculations. Then, each specific calculation generates one of the calculated results according to part or all of the compared results. Finally, the packet class of the network packet is determined according to the calculated results.

According to one exemplary embodiment of the present invention, the method for classifying the network packet further comprises the step as follows. A bit mask is used to extract each specific data of the network packet.

According to one exemplary embodiment of the present invention, the plurality of specific data comprises a network address, a port number, a type of service, and a protocol type, wherein the network address comprises a source network address and a destination network address, and the port number is a transmission control protocol (TCP) port number or a user datagram protocol (UDP) port number.

According to one exemplary embodiment of the present invention, the network packet comprises an increasing/decreasing flag used to determine bits of the plurality of specific data to sort in increasing or decreasing order.

Accordingly, one exemplary embodiment of the present invention provides a fast and flexible method for classifying the network packet. The method for classifying the network packet establishes a basic rule table having different basic rules. The method for classifying the network packet checks whether each specific data of the network packet matches with the corresponding basic rule, so as to output one of logic 1 and logic 0 as a comparison result. Then, according to the composite rule, part or all of the comparison results are chosen to perform a logic operation or a mathematic operation. The flexible and high efficiency method for classifying the network packet is suitable for the design of the network processor, and is easily to be applied on QoS function of the real-time network and the bandwidth guarantee.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flow chart of a method for classifying a network packet according to one exemplary embodiment of the present invention.

FIG. 2 is a schematic diagram of standard format of the conventional network packet according to one exemplary embodiment of the present invention.

FIG. 3 is a schematic diagram of the basic rule table and the composite rule table according to one exemplary embodiment of the present invention.

FIG. 4 is a flow chart of a method for classifying a network packet according to another one exemplary embodiment of the present invention.

### DESCRIPTION OF THE EMBODIMENTS

Reference will now be made in detail to the present preferred embodiment of the invention, examples of which are illustrated in the accompanying drawings.

Wherever possible, the same reference numbers are used in the drawings and the description to refer to the same or like parts.

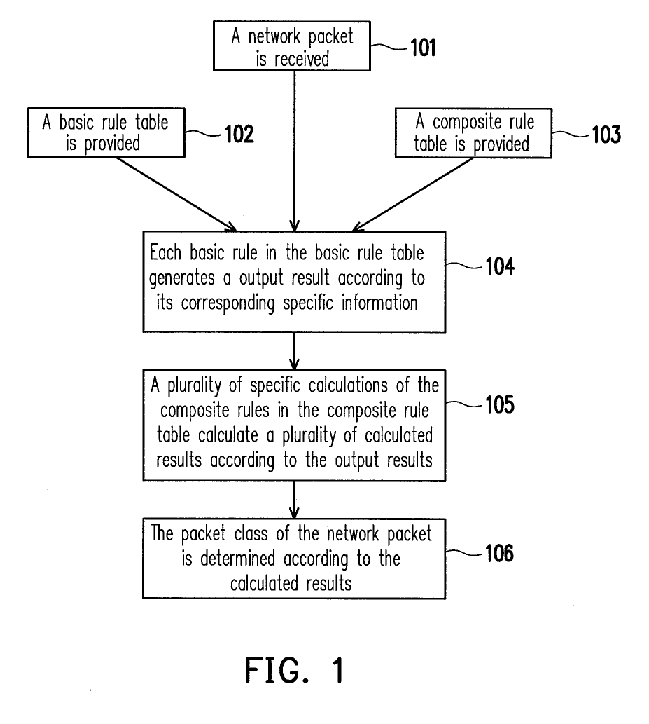

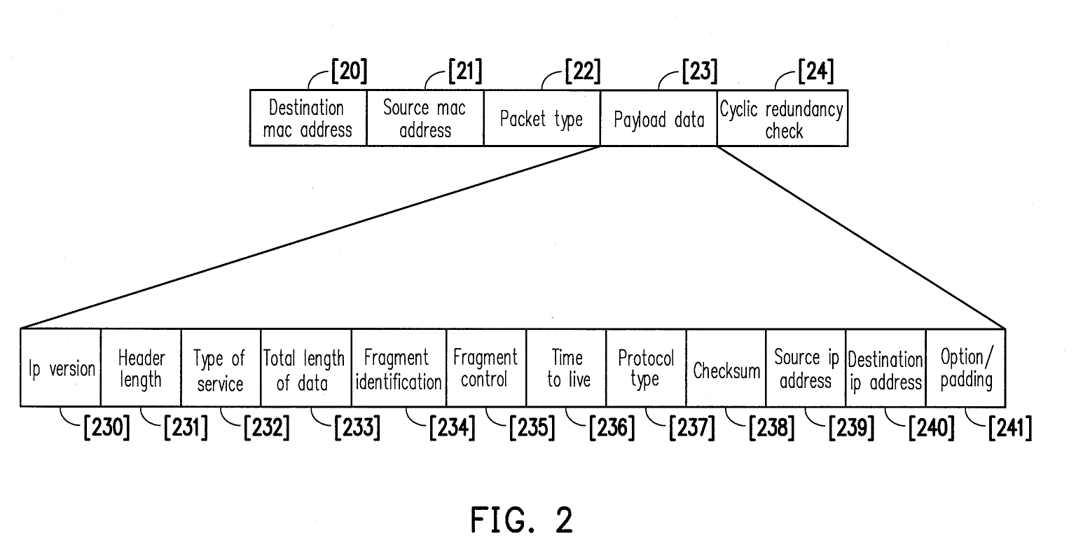

Referring to FIG. 1 and FIG. 2, FIG. 1 is a flow chart of a method for classifying a network packet according to one exemplary embodiment of the present invention, and FIG. 2 is a schematic diagram of standard format of the conventional network packet according to one exemplary embodiment of the present invention.

Wherein the conventional network packet in FIG. 2 is a standard network packet specified in the Ethernet, and has a plurality of specific data. The Ethernet network packet in FIG. 2 comprises the plurality of specific data as follows: a destination MAC address of 24 bits [20], a source MAC address of 24 bits [21], a packet type of 16 bits [22], a payload data [23], and a cyclic redundancy check [24].

Assuming the network packet is transmitted via the widely used IP, the payload data [23] includes the following data: a IP version of 4 bits [230], a header length of 4 bits [231], a type of service of 8 bits [232], a total length of 16 bits [233], a fragment identification of 16 bits [234], a fragment control of 16 bits [235], a time to live of 8 bits [236], a protocol type of 8 bits [237], a checksum of 16 bit [238], a source IP address of 32 bits [239], a destination IP address of 32 bits [240], and a option/padding of 32 bits [241].

The protocol type [237] is the protocol of the intermediate layer between the IP layer and the application layer. In respect of the modern technology, the protocol of the intermediate layer has two protocols, one is TCP, and the other one is user datagram protocol (UDP). The difference between TCP and UDP is that the receiver using TCP must transmit a corresponding acknowledge packet to the sender after the receiver receives a packet from the sender. If the sender does not receives the corresponding acknowledge packet in a reasonable time, the sender will retransmit the corresponding data to the receiver. However, UDP does not have the above mechanism of data reliability, and generally speaking, UDP is usually applied on the streaming media, multimedia game, and voice over IP.

Based upon the knowledge of the standard network packet of the Ethernet, FIG. 1, and the following assumptions, the method for classifying the network packet according to one exemplary embodiment of the present invention is illustrated and described in detail later. Assuming the bandwidth of the application in the network is determined by the packet class thereof, and several conditions are defined as follows according to the application thereof. A user having an IP address, 120.0.1.15, buys the file downloading bandwidth of 1M bits per second for downloading the file packet (generally, the TCP packet) and the audio file downloading bandwidth of 500K bits per second for downloading the audio streaming file packet (generally, the UDP packet) from a Internet Service Provider (ISP) having the IP address, 120.0.1.3.

The ISP defines several basic rules in a basic rule table, and several composite rules in a composite rule table. The basic rule generates an output result according to the corresponding one of the plurality of specific data. For example, the basic rule 1 is defined as “if the source IP address [239] is equal to 128.0.1.3, an logic 1 is output as an output result; otherwise, an logic 0 is output as an output result”, the basic rule 2 is defined as “if the destination IP address [240] is equal to 128.0.1.15, an logic 1 is output as an output result; otherwise, an logic 0 is output as an output result”, the basic rule 3 is defined as “if the protocol type [237] is TCP, an logic 1 is output as an output result; otherwise, an logic 0 is output as an output result”, and the basic rule 4 is defined as “if the protocol type [237] is UDP, an logic 1 is output as an output result; otherwise, an logic 0 is output as an output result”. The others of the plurality of specific data may not used in the basic rules, or used in the different basic rules. Each specific data can be easily obtained by calculating the bytes offset value of the network packet, the bit mask, the increasing/decreasing flag, and the comparative operator.

Although the output result defined by the basic rule is one of logic 0 and logic 1, the output result defined by the basic rule is not limited thereto. Followed with the modification of the following composite rule, the output result defined by the basic rule can be one of several different values.

Next, the specific calculation of the first composite rule is defines as “the logic AND operation of the output result of basic rule 1, the output result of basic rule 2, and the output result of basic rule 3”, the specific calculation of the second composite rule is defines as “the logic AND operation of the output result of basic rule 1, the output result of basic rule 2, and the output result of basic rule 4”. Hence, according to the first composite rule, the network packet which source IP address, destination IP address, protocol type are respectively 128.0.1.3, 128.0.1.15, and TCP, is classified into the first packet class. In the similar manner, according to the second composite rule, the network packet which source IP address, destination IP address, protocol type are respectively 128.0.1.3, 128.0.1.15, and UDP, is classified into the second packet class.

It is noted that, the specific calculation is not limited to the logic AND operation. The specific calculation may be one of all possible logic operations. For example, the specific calculation may be a logic operation formed by the logic OR operation and logic AND operation. Besides, the specific calculation of the composite rule may be a mathematic operation.

The ISP defines the basic rules and the composite rules in all sever nodes in the network. When a network packet having the standard format as FIG. 2 is received, each specific data used in the basic rule table can be extracted by using the bit mask. For example, when the source IP address [239] is to be extracted, the extraction of the source IP address [239] by using the bit mask is described as follows. First, a byte offset value of the source IP address [239] is calculated, i.e. Byte Offset (of source IP address [239])=24 (destination MAC address)+24 (source MAC address)+16 (packet type)+4 (IP version)+4 (header length)+8 (type of service)+16 (total length)+16 (fragment identification)+16 (fragment control)+8 (time to live)+8 (protocol type)+16 (checksum)=160 bits=20 bytes. Then, since the source IP address [239] has 32 bits, a bit mask, such as 0xFFFFFFFF, and the 32 bits from the 21^{th} bytes of the network packet are used to perform the logic bit AND operation. When the logic bit AND operation result is 0x80000103, it means the source IP address [239] is equal to 128.0.1.3, and therefore the output result of the basic rule 1 is logic 1.

In the similar manner, when the destination IP address [240] is to be extracted, the extraction of the destination IP address [240] by using the bit mask is described as follows. First, a byte offset value of the destination IP address [240] is calculated, i.e. Byte Offset (of destination IP address [240])=24 (destination MAC address)+24 (source MAC address)+16 (packet type)+4 (IP version)+4 (header length)+8 (type of service)+16 (total length)+16 (fragment identification)+16 (fragment control)+8 (time to live)+8 (protocol type)+16 (checksum)+32 (source IP address)=192 bits=24 bytes. Then, since the destination IP address [240] has 32 bits, a bit mask, such as 0xFFFFFFFF, and the 32 bits from the 25^{th} bytes of the network packet are used to perform the logic bit AND operation. When the logic bit AND operation result is 0x800001° F., it means the destination IP address [240] is equal to 128.0.1.15, and therefore the output result of the basic rule 1 is logic 1.

Next, after the plurality of specific data are converted into the output results of the basic rules in the basic rule table, the packet class is found via the composite rule table. The composite rule table in fact is the relation between the packet class and the calculated results calculated by a logic operation or a mathematic operation according to the output results of the basic rule table. That is, the composite rule table may not be a table, and people skilled in the art may use the logic function operation program, logic gate, mathematic function operation, and so on to implement the composite rule table.

In short, any mean for achieving the logic function or the mathematic operation to implement the composite rule table falls in the scope the present invention.

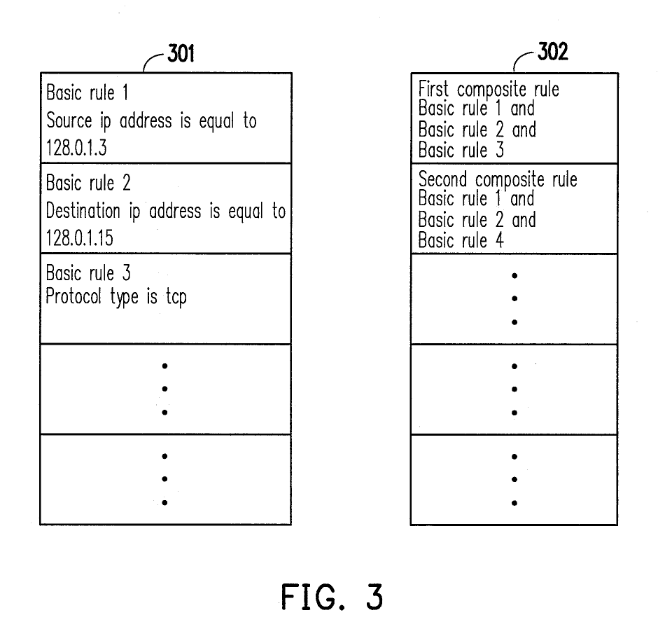

FIG. 3 is a schematic diagram of the basic rule table and the composite rule table according to one exemplary embodiment of the present invention. To conveniently describe the above exemplary embodiment of the present invention, referring to FIG. 3, the output results of basic rule 1 for instance is logic 1 according to the source IP address [239] via the basic rule table, the output results of basic rule 2 for instance is logic 1 according to the destination IP address [240] via the basic rule table, and the output results of basic rule 3 for instance is logic 1 according to the protocol type [237] via the basic rule table. Thus, the network packet matches with the first composite rule in the composite rule table, and the packet class of the network packet is determined as the network packet of the first packet class. Hence, a bandwidth of 1M bits per second is assigned to the network packet.

In addition, the specific calculations of the composite rules may be mathematic operation. The output results of the basic rules may be different values. The above design of the method for classifying the network packet according to one exemplary embodiment of is described later.

In the exemplary embodiment, the output result of the basic rule 1 R1 in response to the corresponding one of the plurality of specific data is assumed to be 1, the output result of the basic rule 2 R2 in response to the corresponding one of the plurality of specific data is assumed to be 2, and the output result of the basic rule 3 R3 in response to the corresponding one of the plurality of specific data is assumed to be 0. In the exemplary embodiment, the specific calculation of the first composite rule F1 is defined to be F1=R1+1.5*R2+2*R3, and the specific calculation of the second composite rule F2 is defined to be F1=2*R1+R2+2*R3. Therefore, under the above assumption, the calculation result of the specific calculation of the first composite rule F1 is 4, and the calculation result of the specific calculation of the second composite rule F2 is 3.5. Next, according to the calculation result of the specific calculation of the first composite rule F1 and the calculation result of the specific calculation of the second composite rule F2, the packet class of the network packet is determined. For example, the calculation result of the specific calculation of the first composite rule F1 and the calculation result of the specific calculation of the second composite rule F2 are compared, and then the packet class of the network packet is determined as the second packet class.

Although the above exemplary embodiment uses the composite rules to assign the different bandwidth to the different packet classes, people skilled in the art may know the composite rule table is implemented by any mean for achieving the logic function or the mathematic operation. That is, in another exemplary embodiment having 10 composite rules, the 5 composite rules may have the same assigned bandwidth. The above exemplary embodiment is just a simple exemplary embodiment which is used to let people skilled in the art understand and kwon the present invention, and the present invention is not limited to the above exemplary embodiment.

According to the network packet classifying rule mentioned above, the method for classifying the network packet is shown in FIG. 1. Referring to FIG. 1, first a network packet having a plurality of specific data is received (step 101). Next, a basic rule comprising a plurality of basic rules is provided, wherein the basic rules correspond to part or all of the plurality of specific data (step 102). Next, a composite rule table comprising a plurality of composite rules is provided, wherein each specific calculation corresponds to one of the packet classes, and each composite rule has one of a plurality of specific calculations (step 103). Each basic rule in the basic rule table generates an output result according to the corresponding one of the plurality of specific data (step 104). The specific calculations of the composite rules in the composite rule table generate a plurality of calculated results according to the output results (step 105). The packet class of the network packet is determined according to the calculated results (step 106).

Wherein, the three steps of receiving the network packet, providing the basic rule table, and providing the composite rule table may be sorted arbitrarily. That is, the present invention is not limited to the order of the three steps, and as shown in FIG. 1, the three steps may execute simultaneously.

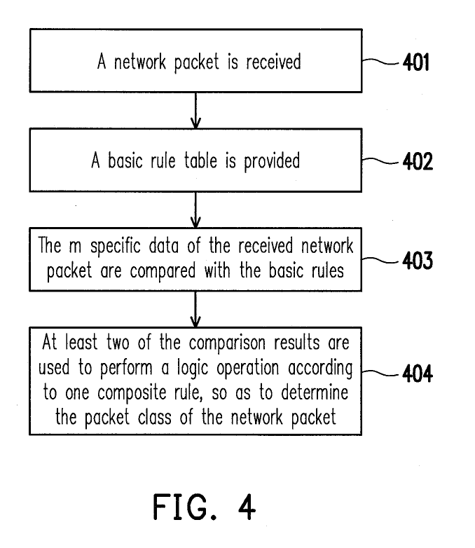

To put it another way, the exemplary embodiment mentioned above can be explained by FIG. 4. Referring to FIG. 4, in the similar manner, at the first step 401, a network packet consisted with a communication protocol is received, wherein the communication protocol specifies N specific data, and N is a nature number. At the second step 503, a basic rule table comprising M basic rules and M specific data is provided, wherein M is a nature number, and M is larger than 0 and less than N+1. At the third step 403, the M specific data of the network packet and the M basic rules are compared with each other, wherein when the one of the plurality specific data corresponding to the i^{th} basic rule matches with the i^{th} basic rule, an i^{th} compared result of a first logic (such as logic 1) is output, and when the one of the plurality of specific data corresponding to the j^{th} basic rule do not match with the j^{th} basic rule, a j^{th} compared result of a second logic (such as logic 0) is output, in which i and j are nature numbers, and 0<i≦M, 0<j≦M. At the final step 404, at least two of the compared results are taken into a logic operation of one of the composite rules, so as to determine the packet class of the network packet. It is noted that, at step 404, not all of the logic operations of the composite rules must be performed to determine the packet class of the network packet. When the specific calculation which calculated result is first true among the calculated results is found and obtained, the packet class of network packet is determined as the packet class corresponding to the calculated result of the composite rules, and the logic operations of the other composite rules will not be performed. In addition, in the other exemplary embodiment, if the calculated results are numeric values but not the logic true or logic false, not all of the mathematic operations of the composite rules must be performed to find the maximum or minimum value of the calculated results. An upper threshold (or a lower threshold) can be added, and if the calculated result of the composite rule among the composite rules is the first one which numeric value is larger than the upper threshold (or less than the lower threshold), the packet class of the network packet is determined as the packet class corresponding to the composite rule.

Accordingly, one exemplary embodiment of the present invention provides a fast and flexible method for classifying the network packet. The method for classifying the network packet establishes a basic rule table having different basic rules. The method for classifying the network packet checks whether each specific data of the network packet matches with the corresponding basic rule, so as to output one of logic 1 and logic 0 as a comparison result. Then, according to the composite rule, part or all of the comparison results are chosen to perform a logic operation or a mathematic operation. The flexible and high efficiency method for classifying the network packet is suitable for the design of the network processor, and is easily to be applied on QoS function of the real-time network and the bandwidth guarantee.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A method for classifying a network packet, comprising:
receiving, at a server node, the network packet comprising a plurality of specific data;
providing, at the server node, a basic rule table comprising a plurality of basic rules, wherein each specific data correspond to one of the basic rules;
providing, at the server node, a composite rule table comprising a plurality of composite rules, wherein each composite rule has one of a plurality of specific calculations, and each composite rule corresponds to one of a plurality of packet classes;
using each basic rule to generate one of a plurality of output results according to the corresponding one of the plurality of specific data;
using each specific calculation to generate one of a plurality of calculated results according to part or all output results; and
determining the packet class of the network packet according to the calculated results.

2. The method for classifying the network packet according to claim 1, further comprising:
using a bit mask to extract each specific data of the network packet.

3. The method for classifying the network packet according to claim 2, wherein the bit mask is determined according to a byte offset corresponding to the one of the plurality of specific data.

4. The method for classifying the network packet according to claim 1, wherein the plurality of specific data comprising:
a network address; and
a port number.

5. The method for classifying the network packet according to claim 1, wherein the plurality of specific data comprising at least one of:
a type of service; and
a protocol type.

6. The method for classifying the network packet according to claim 4, wherein the network address comprises a source network address and a destination network address.

7. The method for classifying the network packet according to claim 4, wherein the port number is a transmission control protocol (TCP) port number or a user datagram protocol (UDP) port number.

8. The method for classifying the network packet according to claim 1, wherein the network packet comprises an increasing/decreasing flag used to determines bits of the plurality of specific data to sort in increasing or decreasing order.

9. A method for classifying a network packet, comprising:
receiving, at a server node, the network packet consisted with a communication protocol, wherein the communication protocol specifies N specific data, and N is a nature number;
providing, at the server node, a basic rule table comprising M basic rules, wherein each of the M basic rules corresponds to one of the N specific data, and M is a nature number, and 0<M≦N;
comparing, at the server node, the M specific data of the network packet with the basic rules,
wherein when the one of the plurality specific data corresponding to the i^{th} basic rule matches with the i^{th} basic rule, an i^{th} compared result of a first logic is output, and
when the one of the plurality of specific data corresponding to the j^{th} basic rule do not match with the j^{th} basic rule, a j^{th} compared result of a second logic is output, in which i and j are nature numbers, and 0<i≦M, 0<j≦M;
providing, at the server node, a plurality of composite rules, wherein each composite rule corresponds to one of a plurality of packet classes, and the composite rules have a plurality of specific calculations; and
using each specific calculation to generate one of the calculated results according to part or all of the compared results; and
determining the packet class of the network packet according to the calculated results.

10. The method for classifying the network packet according to claim 9, wherein the packet class of the network packet is the packet class corresponding to the specific calculation which calculated result is first true among the calculated results.

11. The method for classifying the network packet according to claim 9, further comprising:
using a bit mask to extract each specific data of the network packet.

12. The method for classifying the network packet according to claim 11, wherein the bit mask is determined according to a byte offset corresponding to the one of the plurality of specific data.

13. The method for classifying the network packet according to claim 9, wherein the plurality of specific data comprising:
a network address; and
a port number.

14. The method for classifying the network packet according to claim 9, wherein the plurality of specific data comprising at least one of:
a type of service; and
a protocol type.

15. The method for classifying the network packet according to claim 13, wherein the network address comprises a source network address and a destination network address.

16. The method for classifying the network packet according to claim 13, wherein the port number is a transmission control protocol (TCP) port number or a user datagram protocol (UDP) port number.

17. The method for classifying the network packet according to claim 9, wherein the network packet comprises an increasing/decreasing flag used to determines bits of the plurality of specific data to sort in increasing or decreasing order.
